(19) United States
(12) Patent Application Publication
(10) Pub. No.: US 2011/0292690 A1
(43) Pub. Date: Dec. 1, 2011

(54) Multi-winding high step-up DC-DC converter

(75) Inventors: Tsorng-Juu Liang, Tainan City (TW); Jiann-Fuh Chen, Tainan City (TW); Kuo-Ching Tseng, Yongkang City (TW); Shih-Ming Chen, Tainan City (TW)

(73) Assignee: National Cheng Kung University, Tainan City (TW)

(21) Appl. No.: 13/064,650

(22) Filed: Apr. 6, 2011

(30) Foreign Application Priority Data
May 31, 2010 (TW) 099117438

(51) Int. Cl. H02M 3/335

(52) U.S. Cl. 363/21.12

(57) ABSTRACT

A multi-winding high step-up DC-DC converter includes a three-winding transformer to transform a low DC voltage to a high DC voltage; a power switch to control the energy flux of the primary winding of the three-winding transformer based on turning on/off the power switch; a first diode to control the current of the first secondary winding of the three-winding transformer; a second diode to control the current of the second secondary winding of the three-winding transformer; and a third diode to control the current of the primary winding. When the DC-DC converter is in the first operation state, the switch and the second diode are in on state, and the first and the third diodes are in off state. When the DC-DC converter is in the second operation state, the switch and the second diode are in off state, and the first and the third diodes are in on state.

### BACKGROUND OF THE INVENTION

1. Field of the Invention

The present invention relates to the technical field of voltage conversion and, more particularly, to a multi-winding high step-up DC-DC converter.

2. Description of Related Art

The boost converter is known as a power converter to covert an input DC voltage into an output DC voltage greater than the input DC voltage. The power converter is a switching-mode power supply (SMPS). Generally, boost converters use the tendency of an inductor to resist changes in current. When the inductor is charged, it acts as a load and absorbs energy. When the inductor is discharged, its voltage produced by the inductor relates to the rate of change in current, thereby producing an output DC voltage different from the input DC voltage.

When a boost converter operates in a continuous conduction mode, it has an on state and an off state. Its voltage gain can be expressed as:

$${G}_{v} = \frac{{V}_{OUT}}{{V}_{in}} = \frac{1}{1 - D} ,$$

where D indicates a duty cycle of a switch in the boost converter. Different voltage gains can be obtained by adjusting the duty cycle. Namely, when the duty cycle increases and is close to one, a high output DC voltage is obtained. However, the equivalent series resistance (ESR) reduces the voltage gain and conversion efficiency. Thus, in practice, it is quite difficult to design a boost converter with a high voltage gain.

Flyback converters can be used in both AC/DC and DC/DC conversion with a galvanic isolation between an input and an output. The switch of a flyback converter is subjected to both high voltage and current due to the leakage inductance, resulting in possible damage. Therefore, the devices produced by a high-voltage process are required, and the cost relatively increases.

Some effort has been made in the prior art to use a single switch to convert an input DC voltage into an output DC voltage. However, the voltage gain can be increased obviously only in high duty cycle, and accordingly more control devices are required, resulting in additionally increasing the system cost.

Therefore, it is desirable to provide an improved multi-winding high step-up DC-DC converter to mitigate and/or obviate the aforementioned problems.

### SUMMARY OF THE INVENTION

The object of the present invention is to provide a multi-winding high step-up DC-DC converter, which provides a novel structure and has a power switch without using a high voltage process. An output high DC voltage can be obtained by a low voltage power switch, diodes, and output capacitors to thereby save the cost.

To achieve the object, a multi-winding high step-up DC-DC converter is provided, which converts a low DC voltage into a high DC voltage. The converter includes a three-winding transformer, a power switch, a first diode, a second diode, a third diode, a first capacitor, a second capacitor, a third capacitor, and a fourth capacitor. The transformer receives an input low DC voltage and converts the low DC voltage into a high DC voltage. The power switch is connected to the primary winding of the three-winding transformer to control energy flux of the primary winding of the three-winding transformer based on turning on/off the power switch. The first diode has a positive terminal connected to a first secondary winding of the three-winding transformer in order to control a current of the first secondary winding. The second diode has a negative terminal connected to the first secondary winding of the three-winding transformer in order to control a current of the first secondary winding. The third diode has a positive terminal connected to the primary winding of the three-winding transformer in order to control a current of the primary winding. The first capacitor has one terminal connected to a negative terminal of the first diode, and the other terminal connected to the second secondary winding of the three-winding transformer in order to control the energy flux. The second capacitor has one terminal connected to the second secondary winding of the three-winding transformer, and the other terminal connected to a positive terminal of the second diode in order to control the energy flux. The third capacitor has one terminal connected to a negative terminal of the third diode and the positive terminal of the second diode, and the other terminal connected to a low voltage in order to control the energy flux. The fourth capacitor has one terminal connected to the first secondary winding of the third-winding transformer, and the other terminal connected to the second secondary winding of the third-winding transformer.

Other objects, advantages, and novel features of the invention will become more apparent from the following detailed description when taken in conjunction with the accompanying drawings.

### BRIEF DESCRIPTION OF THE DRAWINGS

FIG. 1 is a circuit of a multi-winding high step-up DC-DC converter according to an embodiment of the invention;

FIG. 2 is a schematic diagram of the converter of FIG. 1 operating in a first operation state according to an embodiment of the invention;

FIG. 3 is a schematic diagram of the converter of FIG. 1 operating in a second operation state according to an embodiment of the invention; and

FIG. 4 shows a comparison of the invention and the prior art on voltage gain and duty cycle.

### DETAILED DESCRIPTION OF THE PREFERRED EMBODIMENT

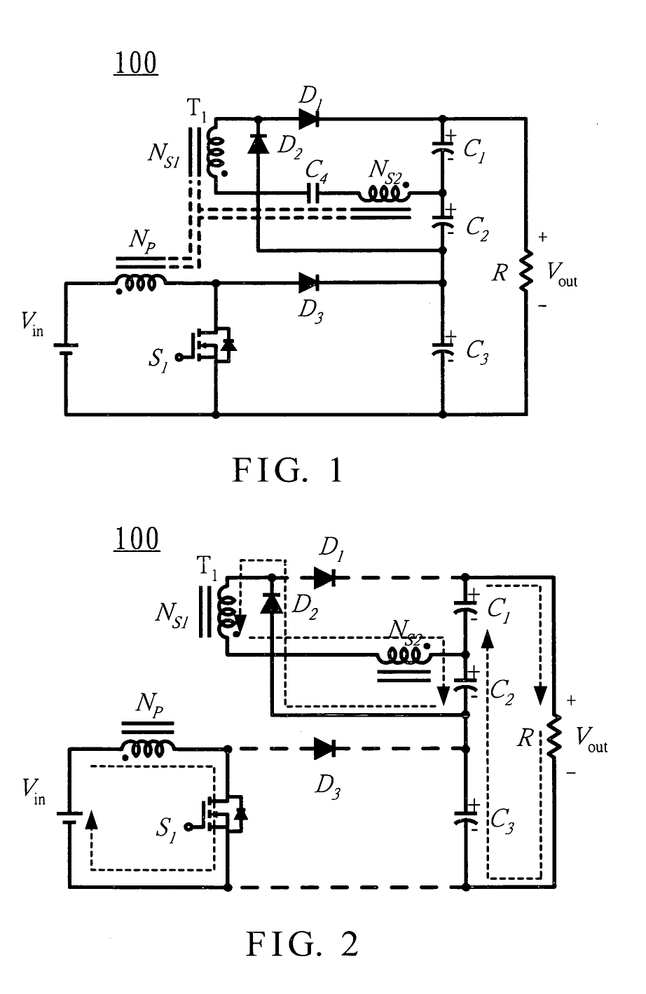

FIG. 1 is a circuit of a multi-winding high step-up DC-DC converter 100 according to an embodiment of the invention. In FIG. 1, the DC-DC converter converts a low DC voltage Vin into a high DC voltage Vout. The DC-DC converter 100 includes a three-winding transformer T1, a power switch S1, a first diode D1, a second diode D2, a third diode D3, a first capacitor C1, a second capacitor C2, a third capacitor C3, and a fourth capacitor C4. The three-winding transformer T1 has a primary winding Np, and two secondary windings Ns1, Ns2.

The three-winding transformer T1 receives an input low voltage direct current (DC) Vin and converts the low DC voltage into a high DC voltage Vout. In the three-winding transformer T1, the turn ratio of the first secondary winding Ns1 to the primary winding Np equals to the turn ratio of the second secondary winding Ns2 to the primary winding Np.

The power switch S1 is connected to the primary winding Np of the three-winding transformer T1 to control energy flux, i.e., energy storage/release, of the primary winding Np of the three-winding transformer T1 based on turning on/off the power switch S1. The power switch S1 can be a low voltage power switch such as an MOS transistor.

The first diode D1 has a positive terminal connected to a first secondary winding Ns1 of the three-winding transformer T1 in order to control a current of the first secondary winding Ns1, i.e., to turn on or off the current of the first secondary winding Ns1. The first diode D1 also has a negative terminal connected to a load R.

The second diode D2 has a negative terminal connected to the first secondary winding Ns1 of the three-winding transformer T1 and the positive terminal of the first diode D1 in order to control a current of the first secondary winding Ns1. The second diode D2 also has a positive terminal connected to the second capacitor C2.

The third diode D3 has a positive terminal connected to the primary winding Np of the three-winding transformer T1, and a negative terminal connected to the positive terminal of the second diode D2 and the second capacitor C2 in order to control the current flowing through the primary winding Np, i.e., to turn on or off the current of the primary winding Np.

The first capacitor C1 has one terminal connected to the negative terminal of the first diode D2 and the load R, and the other terminal connected to the second secondary winding Ns2 of the three-winding transformer T1 in order to control the energy flux.

The second capacitor C2 has one terminal connected to the second secondary winding Ns2 of the three-winding transformer T1 and the other terminal of the first capacitor C1, and the other terminal connected to the positive terminal of the second diode D2 and the negative terminal of the third diode D3 in order to control the energy flux.

The third capacitor C3 has one terminal connected to the negative terminal of the third diode D3 and the positive terminal of the second diode D2, and the other terminal connected to a low voltage in order to control the energy flux.

The fourth capacitor C4 has one terminal connected to the first secondary winding Ns1 of the third-winding transformer T1, and the other terminal connected to the second secondary winding Ns2 of the third-winding transformer T1. The fourth capacitor C4 has the function of DC blocking to thereby prevent the voltage unbalance between the first secondary winding Ns1 and the second secondary winding Ns2.

The DC-DC converter 100 has two operation states in continuous conduction mode.

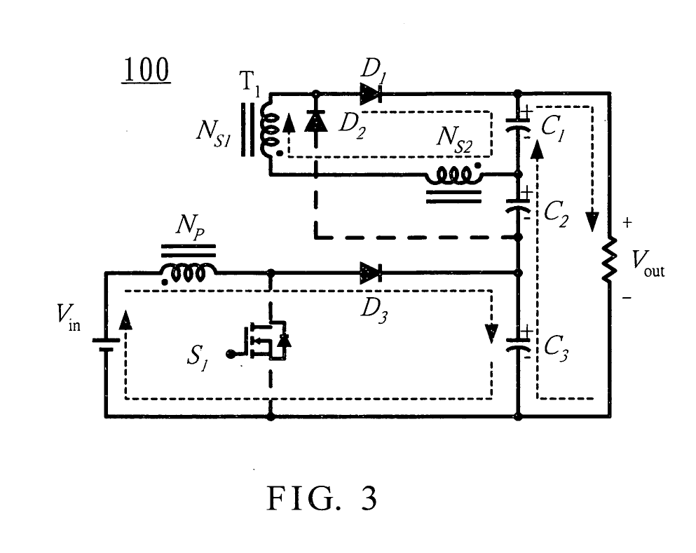

FIG. 2 is a schematic diagram of the DC-DC converter 100 of FIG. 1 in the first operation state according to an embodiment of the invention. FIG. 3 is a schematic diagram of the DC-DC converter 100 of FIG. 1 in the second operation state according to an embodiment of the invention. In continuous conduction mode, it is assumed that the first and the second secondary windings Ns1 and Ns2 have identical feature and structure, and in this case the fourth capacitor C4 can be omitted and regarded as a short-circuit.

As shown in FIG. 2, when the DC-DC converter 100 operates in the first operation state, the power switch S1 and the second diode D2 are turned on, and the first diode D1 and the third diode D3 are turned off.

The current of the low DC voltage Vin flows through the primary winding Np of the three-winding transformer T1 and the power switch S1 to thereby form a loop. The primary winding Np of the three-winding transformer T1 accordingly receives and stores the energy from the input low DC voltage Vin.

Also, the current of another loop flows through the first and second secondary windings Ns1, Ns2 of the three-winding transformer T1, the second capacitor C2, and the second diode D2. The first secondary winding Ns1 of the three-winding transformer T1 accordingly charges the second capacitor C2.

Further, the current of another loop flows through the first capacitor C1, the load R, the second capacitor C2, and the third capacitor C3. The first capacitor C1, the second capacitor C2, and the third capacitor C3 accordingly discharge to the load R.

As shown in FIG. 3, when the DC-DC converter 100 operates in the second operation mode, the power switch S2 and the second diode D2 are turned off, and the first diode D1 and the third diode D3 are turned on.

The current of the low DC voltage Vin flows through the primary winding Np of the three-winding transformer T1, the third diode D3, and the third capacitor C3 to thereby form a loop. The primary winding Np of the three-winding transformer T1 accordingly receives the energy from the input low DC voltage Vin and charges the third capacitor C3.

Also, the current of another loop flows through the first secondary winding Ns 1 of the three-winding transformer T1, the first diode D1, the second winding Ns2 of the three-winding transformer T1, and the first capacitor C1. The energy of the three-winding transformer T1 is accordingly transferred into the first secondary winding Ns1 to charge the first capacitor C1.

Further, the current of another loop flows through the first capacitor C1, the load R, the second capacitor C2, and the third capacitor C3. The first capacitor C1, the second capacitor C2, and the third capacitor C3 accordingly discharge to the load R.

As shown in FIG. 2, when the DC-DC converter 100 operates in the first operation mode, the voltage on the primary winding Np of the three-winding transformer T1 and the voltage on the second capacitor C2 are respectively expressed as:

v_{NP}=Vᵢₙ, (1)

and

v_{C2}=v_{NS1}+v_{NS2}. (2)

In this case, the power switch S1 and the second diode D2 are turned on and thus the voltage thereon is considered to be zero. Since the first and the second secondary windings Ns1 and Ns2 have the same turn ratio, the voltages on the first and the second secondary windings Ns1 and Ns2 are equal as follows:

v_{NS1}=v_{NS2}=nv_{NP}, (3)

where n indicates the turn ratio of the first or second secondary winding Ns1 or Ns2 to the primary winding Np. Accordingly, the voltage on the second capacitor C2 can be rewritten as:

v_{C2}=2nv_{NP}=2nVᵢₙ. (4)

As shown in FIG. 3, when the DC-DC converter 100 operates in the second operation mode, the voltage on the primary winding Np of the three-winding transformer T1 and the voltage on the first capacitor C1 are respectively expressed as:

v_{NP}=Vᵢₙ−v_{C3}, (5)

and

v_{C1}=−v_{NS1}−v_{NS2}=−2v_{NS1}=−2v_{NS2}. (6)

In this case, the first diode D1 and the third diode D3 are turned on and thus the voltage thereon is considered to be zero.

Upon the voltage-second balance principle, the voltage across the primary winding Np of the three-winding transformer T1 is expressed as:

$$\begin{matrix}{\int }_{0}^{{DT}_{S}} {V}_{in} d t + {\int }_{{DT}_{S}}^{{T}_{S}} ( {V}_{in} - {v}_{C 3} ) d t = 0 , and & ( 7 ) \\ {v}_{C 3} = \frac{1}{1 - D} {V}_{in} , & ( 8 )\end{matrix}$$

where D indicates a duty cycle of the power switch S1. In addition, upon the voltage-second balance principle, the voltage across the first secondary winding Ns1 of the three-winding transformer T1 is expressed as:

$$\begin{matrix}{\int }_{0}^{{DT}_{S}} {nV}_{in} d t + {\int }_{{DT}_{S}}^{{T}_{S}} ( \frac{- {v}_{C 1}}{2} ) d t = 0 , and & ( 9 ) \\ {v}_{C 1} = \frac{2 nD}{1 - D} {V}_{in} . & ( 10 )\end{matrix}$$

Accordingly, the output voltage is expressed as:

V_{OUT}=v_{C1}+v_{C2}+v_{C3}. (11)

Equations (4), (8), (10) are applied in equation (11) to find the voltage gain Gv of the DC-DC converter 100 as follows:

$${G}_{v} = \frac{{V}_{OUT}}{{V}_{in}} = \frac{1 + 2 n}{1 - D} . \qquad ( 12 )$$

When the first and the second secondary winding Ns1 and Ns2 of the three-winding transformer T1 have unequal inductance (LNS1≠LNS2), the fourth capacitor C4 can balance the voltage difference (V_{NS1}−V_{NS2}) between the first and the second secondary winding Ns1 and Ns2. The fourth capacitor C4 is an experimental design.

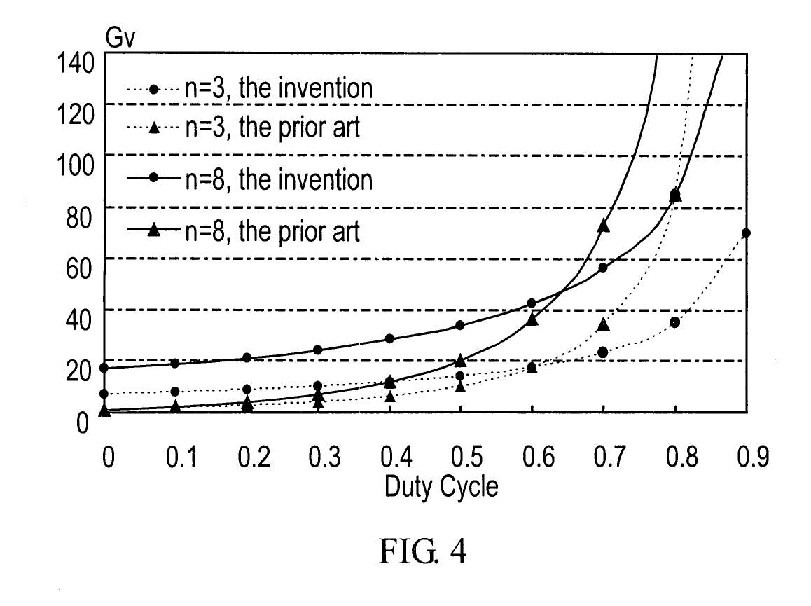

FIG. 4 shows a comparison of the invention and the prior art on voltage gain and duty cycle. Namely, it compares the invention with the article “A Novel Single-Switch High Conversion Ratio DC-DC Converter” issued in PEDS 2009. As shown in FIG. 4, the invention can offer smooth and high gains. In the smooth gain curve, the system is easier in control and has a high steady output. In the high gain curve, the system can obtain a wider range of input voltages. In addition, the invention has a greater voltage gain than the prior art as the duty cycle is about 0.5. For a greater voltage gain, the prior art requires the duty cycle of about 0.6 and above. Due to the higher duty cycle, the transformer and power devices in the prior art require higher scales, and the additional devices are added, thus increasing the system cost and reducing the efficiency. As compared, the invention has a desired voltage gain at the duty cycle of 0.5, i.e., a lower duty cycle. In addition, the prior art requires a coupled-inductor and a power inductor, which adds the cost in comparison with the invention in which only one magnetic device is used.

In view of the foregoing, it is known that the invention provides a novel multi-winding high step-up DC-DC converter formed by a low voltage power switch, diodes, and output capacitors without using any power switch produced by a high voltage process, thereby achieving the output high DC voltage and saving the cost.

Although the present invention has been explained in relation to its preferred embodiment, it is to be understood that many other possible modifications and variations can be made without departing from the spirit and scope of the invention as hereinafter claimed.

What is claimed is:

1. A multi-winding high step-up DC-DC converter for converting an input low DC voltage into a high DC voltage, comprising:
a three-winding transformer for receiving the input low DC voltage and converting the input low DC voltage into the high DC voltage;
a power switch connected to a primary winding of the three-winding transformer to control energy flux of the primary winding of the three-winding transformer based on turning on/off the power switch;
a first diode having a positive terminal connected to a first secondary winding of the three-winding transformer for controlling a current of the first secondary winding;
a second diode having a negative terminal connected to the first secondary winding of the three-winding transformer for controlling the current of the first secondary winding;
a third diode having a positive terminal connected to the primary winding of the three-winding transformer for controlling a current of the primary winding;
a first capacitor having one terminal connected to a negative terminal of the first diode and the other terminal connected to the second secondary winding of the three-winding transformer for controlling the energy flux;
a second capacitor having one terminal connected to the second secondary winding of the three-winding transformer and the other terminal connected to a positive terminal of the second diode for controlling the energy flux;
a third capacitor having one terminal connected to a negative terminal of the third diode and the positive terminal of the second diode, and the other terminal connected to a low voltage in order to control the energy flux; and
a fourth capacitor having one terminal connected to the first secondary winding of the third-winding transformer and the other terminal connected to the second secondary winding of the third-winding transformer.

2. The multi-winding high step-up DC-DC converter as claimed in claim 1, which has two operation states in a continuous conduction mode.

3. The multi-winding high step-up DC-DC converter as claimed in claim 2, wherein, when operating in a first operation state, the power switch and the second diode are turns on, and the first diode and the third diode are turned off.

4. The multi-winding high step-up DC-DC converter as claimed in claim 3, wherein, when operating in the first operation state, the primary winding of the three-winding transformer receives and stores the energy from the input low DC voltage, the first secondary winding of the three-winding transformer charges the second capacitor, and the first, the second, and the third capacitors discharge to a load.

5. The multi-winding high step-up DC-DC converter as claimed in claim 4, wherein, when operating in a second operation state, the power switch and the second diode are turned off, and the first diode and the third diode are turned on.

6. The multi-winding high step-up DC-DC converter as claimed in claim 5, wherein, when operating in the second operation state, the primary winding of the three-winding transformer receives the input low DC voltage and charges the third capacitor, energy of the three-winding transformer is transferred into the first secondary winding to thereby charge the first capacitor, and the first, the second, and the third capacitors discharge to the load.

7. The multi-winding high step-up DC-DC converter as claimed in claim 6, wherein a turn ratio of the first secondary winding to the primary winding equals to a turn ratio of second secondary winding to the primary winding.

8. The multi-winding high step-up DC-DC converter as claimed in claim 7, wherein the power switch is a low voltage power switch.

9. The multi-winding high step-up DC-DC converter as claimed in claim 8, wherein the low voltage power switch is an MOS transistor.

10. The multi-winding high step-up DC-DC converter as claimed in claim 9, which has a voltage gain expressed as:
$${G}_{v} = \frac{{V}_{OUT}}{{V}_{in}} = \frac{1 + 2 n}{1 - D} ,$$
where Gv indicates the voltage gain, n indicates the turn ratio of the first or second secondary winding to the primary winding, and D indicates a duty cycle of the power switch.
